(19) United States
(12) Patent Application Publication
(10) Pub. No.: US 2002/0158914 A1
(43) Pub. Date: Oct. 31, 2002

(54) Method for facilitating easier operation by a user of a device controlled by computer menu selections

(75) Inventor: Rainer Kuth, Herzogenaurach (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/132,846

(22) Filed: Apr. 25, 2002

(30) Foreign Application Priority Data
Apr. 25, 2001 (DE) 10120285.7

(51) Int. Cl. G09G 5/00

(52) U.S. Cl. 345/810

(57) ABSTRACT

In a method for making operation of a device easier, the device being operated with a menu having a tree-like structure and composed of hierarchically organized menu lists with menu selection objects that can in turn again be menu lists, menu selection objects are selected and activated sequentially for the operation and, thus, various paths of the menu are traversed dependent on the selection of the menu selection objects. On the basis of computerized automatic learning of a preferred path, the menu selection objects allocated to this preferred path are emphasized.

### BACKGROUND OF THE INVENTION

1. Field of the Invention

The present invention is directed to a method for making operation of a device easier, the device being of the type operated with a menu having tree-like structure and composed of hierarchically organized menu lists with menu selection objects that can in turn again be menu lists, wherein menu selection objects are sequentially selected and activated for the operation, resulting in various paths of the menu being traversed dependent on the selection of the menu selection objects.

2. Description of the Prior Art

Many devices such as, for example, telephones, telefax machines and medical-technical devices are controlled via menus that are sequentially traversed. These devices usually have a display available for displaying menu selection objects, a device for selecting a displayed menu selection object and a device for effecting a transition to a following menu selection object. The device for selecting a displayed menu selection object is, for example, a computer mouse or a keyboard in combination with a mark mixed into the display that is brought to the selected menu selection object in a well-known way. The device for effecting a transition to a following menu selection object is, for example, a key of the computer mouse, with the selected menu selection object being activated by pressing this key. The menu selection objects are also occasionally referred to as menu points. Menu selection objects can be displayed by alpha-numerical or iconographic symbols.

For more complex menus, the display device usually displays a menu list containing a number of menu selection objects, and a user of the apparatus can select and activate one of the displayed menu selection objects of the menu list, thereby activating a corresponding function of the device or switching to a following menu selection object, that can in turn be a menu list. Further, the menus are organized hierarchically in the form of a tree-like structure of menu lists at every level of the hierarchy.

In such complex menus the user usually has many selection possibilities, causing the operation to be relatively complicated, particularly for an unskilled user.

### SUMMARY OF THE INVENTION

An object of the present invention is to provide a method which creates conditions for easier operation of a device operable with a menu having a tree-like structure.

This object is achieved in a method for easier operation of a device operated with a tree-like menu structure and composed of hierarchally organized menu lists with menu selection objects that can in turn again be menu lists, wherein menu selection objects are selected and activated sequentially for the operation, and thus various paths of the menu are traversed dependent on the selection of the menu selection objects, including the steps of:

a) computerized, automatic learning of a preferred path on the basis of at least one predetermined criterion during a training mode; and

b) computerized emphasizing of the menu selection objects that are assigned to the preferred path.

The invention is based on the recognition that the user of the device often habitually traverses a specific path, i.e. a specific sequence of menu selection objects. In order to facilitate a later operation of the device for the user, the device automatically learns this preferred path on the basis of the predetermined criterion during the training mode, so that those menu selection objects on the display device that are allocated to this preferred path are emphasized given a later operation of the device. The menu selection objects can, for example, be emphasized by presentation in bolder face or larger size than the remaining menu selection objects. A colored emphasis is also conceivable. Due to the emphasis of the menu selection objects, the user quickly recognizes the user's preferred path and can more quickly select and subsequently activate menu selection objects allocated to this preferred path. Due to the emphasis, however, the corresponding menu selection object can also have already been selected, so that the user merely needs to activate this menu selection object by, for example, pressing the input key of a keyboard. A easier and faster operation of the device thus is provided for the user of the device.

According to one version of the invention, the device can be a technical system and/or an information system. Menu-controlled devices are, for example, telephones, telefax machines or other communication terminal devices but are also various devices beyond communications technology. Menu-controlled technical systems are, for example, rolling mills or technical installations comprising a number of menu-controlled machines. One example of an information system is the Internet. In the Internet, for example, there are further Internet pages that can in turn have the form of menu lists that can be selected proceeding from a home page that has the form of a menu list.

When, in a preferred embodiment of the invention, the training mode can be activated during the operation of the device, the emphasis of the menu selection objects can adapt to changed habits of the user. In this case, the training mode and the operation of the apparatus coincide in time, i.e. the learning mode is activated on line. The device thus can also recognize a change in the preferred operation of the apparatus by the user and can thus update the preferred path.

The apparatus can learn the preferred path especially well when, according to one embodiment of the invention, the criterion is a relative frequency of use (selecting) of a path during the operation of the apparatus.

According to a version of the invention, at least one start value has an individual, preferred path allocated to it. The first menu list, i.e. that menu list that is called first during operation of the apparatus, usually contains a number of menu selection objects. A start value can be one of the selected and activated menu selection objects of this fist menu list. If a number of start values are to be allocated to an individual, preferred path, then start values means the selected and activated menu selection object of the first menu list and a selected and activated menu selection object or further selected and activated menu selection objects, of following menu lists, dependent on the number of the start values. A start value, however, also can be an input identifier that an operator of the apparatus must enter at the beginning of operation. An example of a start value according to one embodiment of the invention is an identifier for a user of the apparatus. Preferences of individual users of the apparatus are thus taken into consideration. However, it is also conceivable that a specific user of the apparatus is more skilled than another user of the same apparatus. When the less skilled user then operates the apparatus, the apparatus, instead of emphasizing the preferred path of the less skilled user can, for example, emphasize the preferred path of the more skilled user, so that the less skilled user can benefit from the experience of the more skilled user in a simple way.

In a preferred version of the invention, the apparatus or the technical system is a medical-technical apparatus or medical-technical system since such an apparatus or system often requires very complex menu-controlled operations.

In another embodiment of the invention the start value is a specific feature of a patient to be examined with the medical-technical apparatus or with the medical-technical system. This specific feature according to one preferred version of the embodiment is the age, the weight and/or a tentative (speculated) medical diagnosis of the patient. It is probable that the user, when operating the medical-technical device or the medical-technical system, will traverse the same preferred path given an examination of various patients of similar age, similar weight and/or who are to be examined with the medical-technical apparatus or the medical-technical system because of a similar tentative medical diagnosis.

The apparatus can be operated especially easily when, according to a further version of the invention, the preferred path can be traversed by voice-control and/or with a foot switch. Sterile operation is necessary in the operation of a medical-technical apparatus or a medical-technical system, this being able to be realized advantageously with the use of a foot switch or voice control. The menu selection objects allocated to the preferred path are already emphasized, i.e. selected, so that they merely have to be activated with the foot switch or by voice control. The apparatus thus can be operated without manual intervention, so that the hands of the user do not become non-sterile during the operation of the apparatus.

### DESCRIPTION OF THE DRAWINGS

FIG. 1 schematically illustrates a magnetic resonance apparatus as an example of a device operable with the inventive method.

FIGS. 2 and 3 illustrate for operating the magnetic resonance apparatus, menu lists of a sequentially traversed menu for explaining the inventive method.

### DESCRIPTION OF THE PREFERRED EMBODIMENTS

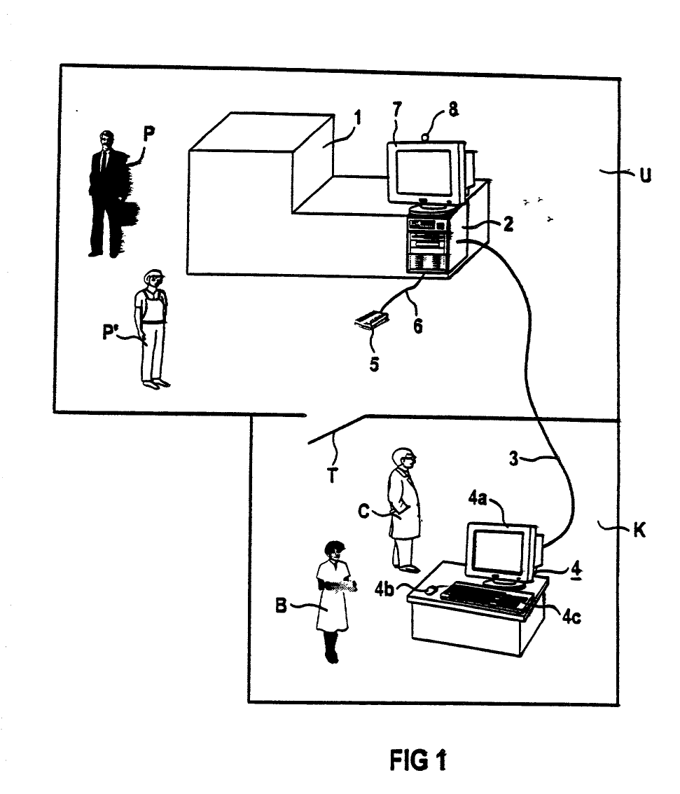

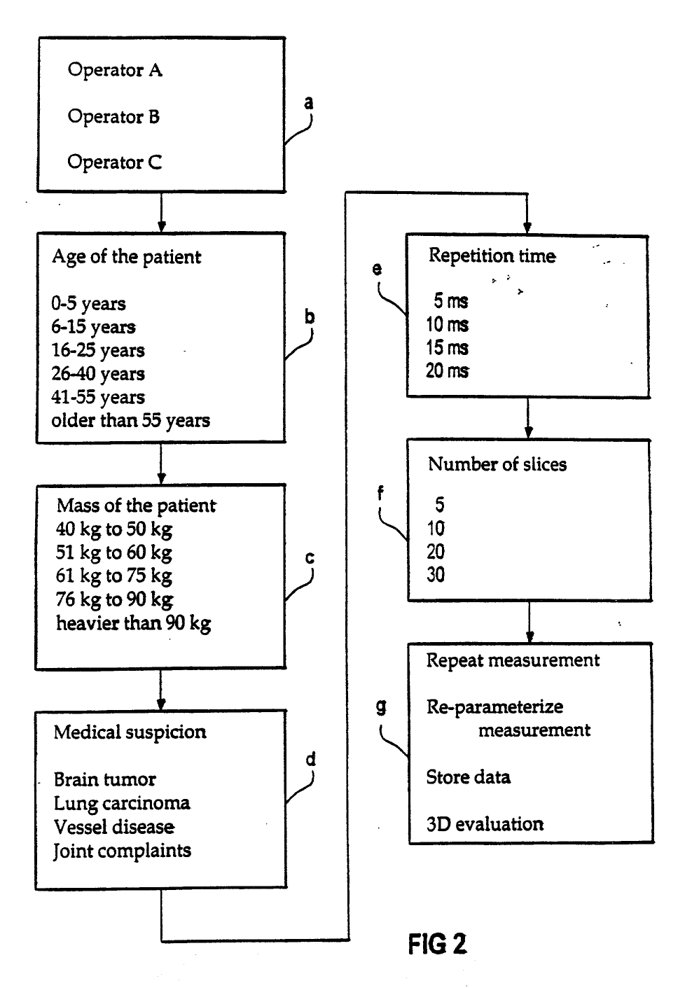

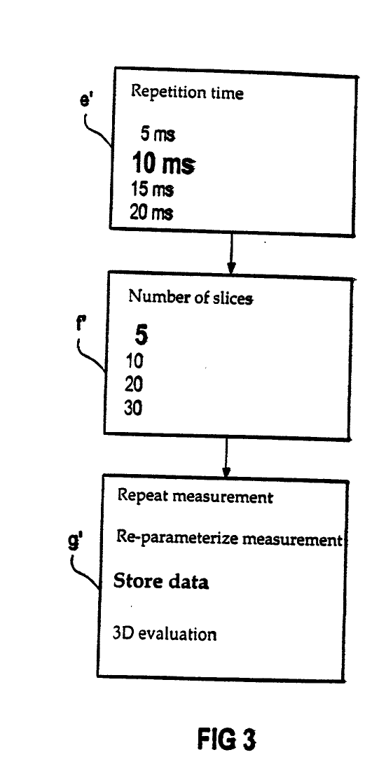

FIG. 1 schematically shows a magnetic resonance apparatus 1 located in an examination room U that can be controlled with a menu whose executive sequence is shown by way of example in FIGS. 2 and 3. The menu is stored on a suitable computer program that can in turn be called on a control computer 2 of the magnetic resonance apparatus 1.

In a well-known way, the menu has a number of menu lists that in turn contain a menu selection object or a number of menu selection objects. In the case of the present exemplary embodiment, the menu lists are displayed at a monitor 4a of a control console 4 of the magnetic resonance apparatus 1 located in a control room K. The control console 4 also has a computer mouse 4b and a keyboard 4c and is connected to the control computer 2 via an electrical line 3. The control room K is connected to the examination room U by a door T.

In the exemplary embodiment, a further, suitable computer program is stored on the control computer 2 that, during a training mode and on the basis of start values yet to be described in greater detail and on the basis of the relative frequency of a path emanating from these start values, determines a preferred path in the operation of the magnetic resonance apparatus 1. Proceeding from the start values, the preferred path is thus that path that is traversed most often.

When an operator B wishes to examine a patient P with the magnetic resonance apparatus 1, the operator B switches the magnetic resonance apparatus 1 on, after which a menu list “a” shown in FIG. 2 is built up on the monitor 4a, this menu list “a” containing the menu selection objects “operator A”, “operator B” and “operator C” in the present exemplary embodiment. Following thereupon, the operator B selects the menu selection object “operator B”, in that the operator B moves a mark (not shown in FIG. 2 but notoriously known) that is mixed into the menu list “a” to the menu selection object “operator B” with the computer mouse 4b. After the operator B has selected the menu selection object “operator B”, the operator B activates it in that the operator clicks on it with the computer mouse 4b in a well-known way.

Following thereupon, a further menu list “b” with menu selection objects “0 through 5 years”, “6 through 15 years”, “16 through 25 years”, “26 through 40 years”, “41 through 55 years” and “older then 55 years” is built up on the monitor 4a, the operator B selecting the approximate age of the patient P with the assistance thereof. In the case of the present exemplary embodiment, the patient P is 35 years old, whereupon the operator B selects and activates the menu selection object “26 through 40 years”.

Following thereupon, a further menu list “c” with menu selection objects “40 kg through 50 kg”, “51 kg through 60 kg”, “61 kg through 75 kg”, “76 kg through 90 kg” and “heavier then 90 kg” is built up on the monitor 4a, the operator B selecting the approximate mass of the patient P with the assistance thereof. The patient P weighs approximately 80 kg, whereupon the operator B selects and activates the menu selection object “76 kg through 90 kg”.

Subsequently, a further menu list “d” is built up on the monitor 4a, the operator B selecting a medical suspicion of the patient P with the assistance thereof. The medical suspicion is, for example, allocated to a sickness or a specific injury of the patient. In the exemplary embodiment, the menu list “d” contains menu selection objects “brain tumor”, “lung carcinoma”, “vessel condition” and “joint complaints”. In the exemplary embodiment, the patient P is complaining of headaches, for which reason the operator B selects and activates the menu selection object “brain tumor”.

In the exemplary embodiment, the start values to which a preferred path is allocated are a combination of selected menu selection objects of the menu lists a, b, c and d. As an example, the menu selection objects “operator B”, “26 through 40 years”, “76 kg through 90 kg” and “brain tumor” are described above as a combination of start values.

In the exemplary embodiment, further, a path with this combination of start values has not yet been traversed, so that a preferred path is not yet allocated to this combination of start values, i.e. menu selection objects of following menu lists have not yet been especially emphasized after the activation of the menu selection object “brain tumor”.

After the selection and activation of the menu selection object “brain tumor”, a menu list “e” with selection objects “5 ms”, “10 ms”, “15 ms” and “20 ms” that is shown in FIG. 2 is built up on the monitor in the case of the present exemplary embodiment, the operator B selecting the repetition time for a measurement with the magnetic resonance apparatus 1 with the assistance thereof. In the exemplary embodiment, the operator B selects and activates the menu selection object “10 ms”.

Following thereupon, a further menu list “f” with menu selection objects “5”, “10”, “20” and “30” is built up on the monitor 4a, the operator B selecting a number of slices for the measurement with the magnetic resonance apparatus 1 with the assistance thereof. In the exemplary embodiment, the operator B selects a slice number of 5 in that the operator B clicks on the menu selection object “5” with the computer mouse 4b. The measurement with the magnetic resonance apparatus 1 begins thereafter.

When the measurement with the magnetic resonance apparatus 1 has ended, a further menu list “g” with menu selection objects “repeat measurement”, “re-parameterized measurement”, “stored data” and “3D evaluation” is built on the monitor 4b. Since the operator B would like to store data that are allocated to the images produced with the magnetic resonance apparatus 1 on a hard disk of the control computer 2, i.e. neither wishes to repeat the measurement, to re-parameterized the measurement nor wishes a 3D evaluation, the operator B clicks on the menu selection object “store data” with the computer mouse 4b.

As stated above, a path proceeding from the combination of start values “operator B”, “26 through 40 years”, “76 kg through 90 kg” and “brain tumor” has not yet been traversed in the case of the present exemplary embodiment. The computer programs stored in the control computer 2 was thus not yet capable of determining a preferred path, for which reason none of the menu selection objects of one of the menu lists e through g shown in FIG. 2 are emphasized compared to the remaining menu selection objects of the same menu lists.

With operation of the magnetic resonance apparatus 1, the computer program stored on the control computer 2—proceeding on the basis of the combination of start values of the menu lists a through d—recognizes that path that it is being traversed at the moment and determines that path that was traversed most frequently up to this point in time proceeding from this combination of start values. In the exemplary embodiment, thus, the training mode is constantly activated. This path is classified as preferred path proceeding from this combination of start values.

In exemplary embodiment, the operator B usually traverses the above-described path when examining a patient between 26 and 40 years old weighing between 76 kg and 90 kg and having a medical suspicion of a brain tumor. Proceeding from the combination of start values “operator B”, “26 through 40 years”, “76 kg through 90 kg” and “brain tumor”, this path is thus the preferred path that is allocated to this combination of start values. In the exemplary embodiment after the preferred path was identified, those menu selection objects of the menu lists e through g that are allocated to this preferred path are presented bolder face and larger than the remaining menu selection objects. As schematically shown in FIG. 3, the menu selection objects “10 ms”, “5” and “stored data” are presented bolder face and larger.

In the exemplary embodiment, a further patient P′ shown in FIG. 1 is examined with the magnetic resonance apparatus 1, this further patient P′ being 37 years old, weighing 80 kg and likewise having a medical suspicion of a brain tumor. The patient P′ is examined at a later time than the patient P. The operator B likewise operates the magnetic resonance apparatus 1, i.e. the operator clicks on the menu selection objects “operator B”, “26 through 40 years”, “76 kg through 90 kg” and “brain tumor” of the menu lists a through d with the computer mouse 4b. Subsequently, the computer program stored on the control computer 2 automatically recognizes the preferred path allocated to this combination of start values and presents the menu selection objects “10 ms”, “5” and “stored data” of the following menu lists that are allocated to this preferred path bolder face and larger. These menu lists are shown as menu lists e′, f′ and g′ in FIG. 3.

When examining the patient P′, thus, the operator B can traverse the preferred path faster during operation of the magnetic resonance apparatus 1, since the menu selection objects allocated to this path have already been emphasized, i.e. selected. The operator B therefore need not select the corresponding menu selection object with the computer mouse 4b and the mark. When the operator wishes to traverse the preferred path, the operator merely only has to activate the corresponding menu selection objects in that the operator, for example, presses the input key of the keyboard 4c in a notoriously known way.

As an alternative in the exemplary embodiment, this input can also ensue with a foot switch 5 that is located in the control room K and is connected to the control computer 2 with an electrical line 6. To this end, a further monitor 7 connected to the control computer 2 is located in the examination room U, this further monitor 7 likewise displaying the current menu list during the operation of the magnetic resonance apparatus 1. The input can alternatively ensue by means of a microphone 8 that is integrated in the monitor 7 and is connected (in a way that is not shown) to the control computer 2. A further suitable computer program is stored in the control computer 2 for this purpose, this, for example, interpreting clapping of hands as an input, so the preferred path can be traversed in a simple way. The microphone 8 also, or alternatively, can receive voice commands, which one interpreted by a known voice control program.

If, over the course of time, the operator B happens to traverse a different path proceeding from the combination of start values than the preferred path that has been classified until then, then this is recognized by the control computer 2. If this new path is traversed more frequently after a certain time than the preferred path, this new path is classified as new, preferred path by the computer program stored on the control computer 2 and is emphasized in the future. Based on the relative frequency of occurrence of a traversed path, the preferred path is thus automatically updated as warranted.

Further preferred paths that are not explicitly indicated in FIGS. 2 and 3 and that are allocated to respectively further start values are also stored in the control computer 2.

Another operator C shown in FIG. 1 who, for example, has less skill in the operation of the magnetic resonance apparatus 1 can benefit from the experience of operator B when the operator C selects the menu selection object “operator B” of the menu list “a” given operation of the magnetic resonance apparatus 1, so that the control computer indicates the preferred path allocated to operator B on the monitors 4a and 7.

The inventive method need not necessarily be applied to a magnetic resonance apparatus 1. It is also employable for other medical-technical apparatus or systems. The described values are likewise only as examples. More or fewer start values or even only one start value can also be employed.

It is also not necessary that the training mode be constantly activated. It is also conceivable for the training mode to be activatable or deactivatable.

The foot switch and voice control input are also optional.

The inventive method is also not limited to the medical field. It can also be employed for telephones, telefax machines or for an information system such as the Internet as well.

Although modifications and changes may be suggested by those skilled in the art, it is in the intention of the inventor to embody within the patent warranted hereon all changes and modifications as reasonably and properly come within the scope of his contribution to the art.

I claim as my invention:

1. A method for operating a device comprising the steps of:
operating a medical apparatus being adapted for interaction with a patient by operator inputs made by an operator at a computer connected to the device;
at said computer, displaying a menu have tree-like configuration composed of hierarchically organized menu lists with menu selection objects, said menu selection objects being selectable and activatable in a sequence by an operator for operating said medical apparatus thereby creating a plurality of paths in said menu that are followed dependent on the selection of said menu selection objects;
in a training mode, automatically learning a preferred path in said computer, from among said various paths, dependent on at least one predetermined criterion, said preferred path being allocated to a characterizing feature of said patient; and
at said computer, emphasizing menu selection objects associated with said preferred path based on said characterizing feature of said patient.

2. A method as claimed in claim 1 comprising activating said training mode in said computer during an operation of said device.

3. A method as claimed in claim 1 comprising employing, as said at least one predetermined criterion, a relative frequency of occurrence of a selected path during operation of said device.

4. A method as claimed in claim 1 comprising providing a start value at said computer, and allocating said preferred path in said computer to said start value.

5. A method as claimed in claim 1 comprising identifying a start value in said computer associated with said preferred path, and employing said characterizing feature of said patient as said start value.

6. A method as claimed in claim 5 comprising selecting said characterizing feature from the group consisting of the age of the patient, the weight of the patient and a tentative medical diagnosis of said patient.

7. A method as claimed in claim 1 comprising traversing said preferred path via said computer by voice-controlled operation.

8. A method as claimed in claim 1 comprising traversing said preferred path via said computer by foot switch-controlled operation.
